(19) United States
(12) Patent Application Publication
(10) Pub. No.: US 2023/0339352 A1
(43) Pub. Date: Oct. 26, 2023

(54) Mobile Charge Device

(71) Applicant: Jason Folchert, Casper, WY (US)

(72) Inventor: Jason Folchert, Casper, WY (US)

(21) Appl. No.: 18/300,424

(22) Filed: Apr. 14, 2023

Related U.S. Application Data
(60) Provisional application No. 63/333,195, filed on Apr. 21, 2022.

(51) Int. Cl. B60L 53/57; B60L 53/16; B60L 53/53; B60L 53/80; B60S 5/06

(52) U.S. Cl. CPC B60L 53/57; B60L 53/16; B60L 53/53; B60L 53/80; B60S 5/06; B60L 53/18

(57) ABSTRACT

The present invention relates to a novel mobile charge device. The device is a multifunctional truck designed to charge stranded electric vehicles. The truck device is similar to a tow truck but also comprises a very large battery positioned in its rear portion. The large battery comprises a plurality of charging cables, which extend outward from the battery system. The charging cables are designed to allow the truck device to charge stranded electric vehicles. Further, the charging cables are designed to accommodate any make or model of electric vehicle. Thus, the truck device is useful for helping prevent electric vehicle owners from being stranded for long periods of time without battery charge.

### CROSS-REFERENCE TO RELATED APPLICATION

The present application claims priority to, and the benefit of, U.S. Provisional Application No. 63/333,195, which was filed on Apr. 21, 2022, and is incorporated herein by reference in its entirety.

### FIELD OF THE INVENTION

The present invention relates generally to the field of mobile charge devices. More specifically, the present invention relates to a mobile tow truck-style vehicle that can respond to stranded electric vehicles with no battery charge. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in mobile charge devices. Generally, despite electric vehicles becoming increasingly common, locating charging stations while traveling can be difficult. Further, batteries losing their charge while away from home can leave people stranded in dangerous locations. Additionally, purchasing a tow truck just to retrieve an electric vehicle with a dead battery can be frustrating.

Although electric vehicles (“EV(s)”) are becoming more popular, the lack of availability and access to public charging stations for the charging of EVs remains one of the top hindrances to widespread EV adoption. The high cost of construction and charging equipment hinders the deployment of public EV charging stations. As such, the current state of public charging stations is about 17,000 EV stations, hardly comparable in geographical distribution and density to the number of gasoline stations which number around 170,000. Thus, an EV driver usually has to take a lengthy detour from the intended travelling route just to charge at such public EV stations before resuming their journey.

Accordingly, a need remains for a mobile, electric vehicle power charging device that has the ability to charge multiple EVs and can be moved to a desired location, as needed. Further, the mobile, electric vehicle power charging device can also operate as a tow truck, if a vehicle needs to be towed.

Therefore, there exists a long-felt need in the art for a mobile charge device that provides users with a mobile tow truck-style vehicle that can respond to stranded electric vehicles with no battery charge. There is also a long-felt need in the art for a mobile charge device that allows users to call the truck operator and obtain battery charge via a charging port on the truck. Further, there is a long-felt need in the art for a mobile charge device that comprises multiple charging ports to accommodate any make or model of electric vehicle. Moreover, there is a long-felt need in the art for a device that functions as a standard tow truck if a tow is needed for any vehicle. Further, there is a long-felt need in the art for a mobile charge device that prevents electric vehicle owners from being stranded long term while traveling if they deplete their battery. Finally, there is a long-felt need in the art for a mobile charge device that can charge multiple electric vehicles via the multiple charging ports.

The subject matter disclosed and claimed herein, in one embodiment thereof, comprises a mobile charge device. The device is a multifunctional truck designed to charge stranded electric vehicles. The truck device is similar to a tow truck but also comprises a very large battery positioned in its rear portion. The large battery comprises a plurality of charging ports, which extend outward from the battery system. The charging ports are designed to allow the truck device to charge stranded electric vehicles. Further, the charging ports are designed to accommodate any make or model of electric vehicle. Thus, the truck device is useful for helping prevent stranded electric vehicle owners from being stranded for long periods of time without battery charge.

In this manner, the mobile charging device of the present invention accomplishes all of the foregoing objectives and provides users with a truck device that provides mobile charging for stranded electric vehicles. The device is a multifunctional truck device that can accommodate any make or model of electric vehicle. The device can also function as a standard tow truck.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobile charge device. The device is a multifunctional truck designed to charge stranded electric vehicles. The truck device is similar to a tow truck but also comprises a very large battery positioned in its rear portion. The large battery comprises a plurality of charging ports, which extend outward from the battery. The charging ports are designed to allow the truck device to charge stranded electric vehicles. Further, the charging ports are designed to accommodate any make or model of electric vehicle. Thus, the truck device is useful for helping prevent stranded electric vehicle owners from being stranded for long periods of time without battery charge.

The growing deployment of electric vehicles create a need for widespread electrical chargers that are conveniently and strategically located at points of interest. In one embodiment, the mobile charge device comprises a large battery and a plurality of charge ports for charging electric vehicles. The battery and charge ports are incorporated into a mobile charging platform such as a truck, a tow truck, a van, or other suitable vehicle that can be transported, and which can then be dispatched on an “as-needed” basis to meet a requesting driver of an electric vehicle (“EV”) at a pre-arranged location for a charging session. In one embodiment, the mobile charge device comprises a tow truck that is also able to tow the EV, if needed.

Further, communications between the mobile charge device and the EV are accomplished using software applications, texts, emails, phone calls, etc. In every particular embodiment of the invention, the mobile charge device is a motorized vehicle, not a device that is passively carried or pulled.

In one embodiment, the mobile charge device comprises a chassis (or body), which is substantially supported by approximately four to six wheels. Wheels can be selected to permit the mobile charge device to travel on road and/or off road, as desired. The chassis can additionally include an operator's compartment or cab from which the battery and charging ports can be operated. The operator's compartment can include windows or viewing ports to permit the operator/driver to see outside the compartment. In one particular embodiment of the invention, the operator's compartment is mounted to the front portion of the chassis. Additionally, a steering mechanism is provided within the operator's compartment to enable an operator to steer the wheels and to proceed in the forward and reverse directions.

Additionally, the mobile charge device comprises a large battery or battery system (i.e., multiple batteries connected together), wherein each battery comprises a plurality of charging ports or electrical sockets for connection to an electric vehicle to be charged or to an external charging source. For example, the charging ports permit the electric vehicles to be attached, via their charging cords to the battery, to charge the electric vehicle or the charging ports can be used to attach the battery to an external power source, such as an off-grid or on-grid power supply.

Furthermore, each battery stores a maximum of approximately 100 DC volts which can be drawn upon for recharging an electric vehicle. The battery may supply power for the mobile charge device, or an engine powered electrical generator. In one embodiment, the mobile charge device would comprise a Level-1, Level-2, or Level-3 charger. A Level-2 charger would take at least an hour to provide sufficient charge for the EV to travel between 25 to 50 miles. A Level-3 DCFC fast charger may only require 15 minutes of charging time to provide the equivalent amount of charge as a Level-2 charger taking 2 hours.

All Level-1, Level-2, and/or Level-3 chargers and associated equipment and accessories are compliant with current governing standards of design and use, and as standards evolve and are adopted, this invention assumes compliance with all necessary standards and governing bodies.

Further, electricity produced from a power source is regulated by a regulator and stored in the battery or batteries. In one embodiment, the mobile charge device employs multiple power sources for its own recharging during operation. In one embodiment, the mobile charge device includes solar panels and a wind turbine for generating power from the wind. Power generated is stored in a battery or batteries in combination with supercapacitors onboard the mobile charge device.

In the embodiment where a battery system is utilized, the battery system may be replenished either continuously or occasionally via plugging into the grid, or by trickle charging via an on-board solar cell array(s), a wind generator, or even a small powered electrical generator. In other words, the mobile charge device's battery system must be recharged whenever it is discharged in charging an EV, and this invention contemplates some mechanism for recharging the onboard charger battery system.

Specifically, the mobile charge device described herein, by way of its multiple charging mechanisms, has the ability to operate continuously with no external recharging connection, such as the electrical grid, as well as having the ability to recharge other separate electrical vehicles requiring a charge in any remote or urban location.

Additionally, since power can be received from, and provided to, the mobile charge device, electrical connections, sockets, or outlets are placed at various locations on the mobile charge device. Electrical connections permit the mobile charge device to be recharged from an external source, as well as providing power to other electric vehicles that need to be charged.

In another embodiment, the device may utilize modules of removable batteries wherein the electric vehicle may simply exchange charge depleted batteries for a set of fully charged batteries, and thus eliminate the waiting time associated with charging the electric vehicle's onboard batteries.

Accordingly, the mobile charge device consists of a vehicle or other transportable platform/container that is equipped with chargers powered by electricity generators that run on gasoline, diesel fuel, or another motor powered source, or banks of batteries capable of supplying continuous direct current that may be used as is, or converted to various DC voltages, or converted into AC power, or modules of removable batteries that can be exchanged with depleted batteries in the electric vehicle.

Further, the mobile charge device comprises charging circuitry which utilizes power from either the local power grid or a local battery source to generate a charging current that is output via the charge port to the electric vehicle being charged. The charging circuitry can receive the charging power from either the electrical power grid via an electric grid connection or a local battery. The electric grid connection would comprise a standard power interface to the local power grid. A battery would locally store electricity that was provided via some type of power generation interface or from the electric grid connection. The power generation interface could be connected to a solar, wind, or other type of power generation system.

This invention also contemplates the need for the mobile charge device to carry different charger types and charging cables to manage compatibility with different makes of EVs. Specifically, EV designs usually differ in make and model of EVs as each may be equipped with different battery technology, different charging mechanisms, and battery management systems, capacity, etc. Thus, each EV has a charging protocol that may differ from one another, such as in the charging rate, ambient temperature, etc. The mobile charge device controls these protocols and monitors the amount of energy used in recharging the EV, the time of the charging sequence, etc. Thus, the mobile charge device provides the ability to match brand specific electric vehicles with brand compatible charging units.

The mobile charge device further includes a software mobile application for providing communications and control from the mobile charge device through a wireless communication interface. In general, these apps are software applications running on smart devices with wireless connectivity and access to the internet. The mobile charge device is continuously tracked, and its itineraries are refreshed continuously as submitted by the operator/driver on the software mobile application. When a driver submits a routing plan via the mobile app that is connected to the internet cloud or other wireless communication network/environment, a user can determine whose operating areas coincide with the user's position. The mobile charge device can also be tracked via GPS. Further, the software application can provide for electronic recordkeeping and payment processing. However, payment mechanisms are universally available from third parties and other forms of payment processing can be utilized as well, such as the use of on-site magnetic card readers, smart chip card readers, and even online internet data entry through third-party portals for payment processing.

In one embodiment, multiple mobile charge devices are utilized to allow at least one mobile charge device to be available around the clock, 7 days a week and 24 hours a day. The mobile charge device can be continuously monitored and tracked via the software application and GPS. Specifically, the mobile application provides position information using various applications, such as GPS, cell tower triangulation techniques, or using location sensitive beaconing technologies such as Apple Computer's Bluetooth app, iBeacon, to locate the electric vehicle. Accordingly, users can make any requests for charging directly on the software application or directly with the driver. Thus, bookings between the mobile charge device and the user may be made either by manual interaction between a driver or through the app.

Thus, the mobile charge device provides a roving charging station on a moving platform, such as a tow truck equipped with fossil fuel motorized electric generators or a bank of batteries that are either charged from the normal grid outlet, such as 110 V AC wall circuit, and/or are continuously charged on the road via onboard solar panels or energy collection mechanism, such as wind turbines or the vehicles 12 V DC output.

It will be appreciated by those skilled in the art having the benefit of this disclosure that the mobile charge device provides a tremendous utility to the EV driver while reducing the need for, and cost of, installing fixed EV charging stations that can never keep up with the growth of EV adoption. Mobile EV charging stations also remove, or greatly reduce, range anxiety or the fear of running out of battery charge far away from fixed EV charging stations. By enabling EV charging stations to be mobile, drivers need not delineate from taking direct routes to their intended destinations merely to be close to fixed EV charging stations that are out of their intended trip paths.

In yet another embodiment, the mobile charge device comprises a plurality of indicia.

In yet another embodiment, a method of charging a stranded electric vehicle is disclosed. The method includes the steps of providing a mobile charge device comprising a tow truck with a large battery and multiple charging ports. The method also comprises driving the truck device to the stranded electric vehicle. Further, the method comprises securing the charging cable of the electric vehicle to the charging port of the device. The method also comprises charging the electric vehicle via the device. Finally, the method comprises towing the electric vehicle, if necessary.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of the mobile charge device of the present invention showing the device in use in accordance with the disclosed architecture;

FIG. 2 illustrates a side perspective view of one embodiment of the mobile charge device of the present invention showing the battery system on the truck device in accordance with the disclosed architecture;

FIGS. 3A-B illustrate a side perspective view of one embodiment of the mobile charge device of the present invention showing how an electric vehicle is plugged into one of the charge ports of the device in accordance with the disclosed architecture;

FIG. 4 illustrates a side perspective view of one embodiment of the mobile charge device of the present invention showing how the charging port can accommodate several different charger models in accordance with the disclosed architecture;

FIG. 5 illustrates a side perspective view of one embodiment of the mobile charge device of the present invention showing the truck device functioning as a standard tow truck in accordance with the disclosed architecture; and

FIG. 6 illustrates a flowchart showing the method of charging a stranded electric vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a mobile charge device that provides users with a mobile tow truck-style vehicle that can respond to stranded electric vehicles with no battery charge. There is also a long-felt need in the art for a mobile charge device that allows users to call the truck operator and obtain battery charge via a charging port on the truck. Further, there is a long-felt need in the art for a mobile charge device that comprises multiple charging ports to accommodate any make or model of electric vehicle. Moreover, there is a long-felt need in the art for a device that functions as a standard tow truck if a tow is needed for any vehicle. Further, there is a long-felt need in the art for a mobile charge device that prevents electric vehicle owners from being stranded long term while traveling if they deplete their battery. Finally, there is a long-felt need in the art for a mobile charge device that can charge multiple electric vehicles via the multiple charging ports.

The present invention, in one exemplary embodiment, is a novel mobile charge device. The device is a multifunctional truck designed to charge stranded electric vehicles. The truck device is similar to a tow truck but also comprises a very large battery positioned in its rear portion. The large battery comprises a plurality of charging ports, which extend outward from the battery system. The charging ports are designed to allow the truck device to charge stranded electric vehicles. Further, the charging ports are designed to accommodate any make or model of electric vehicle. The present invention also includes a novel method of charging a stranded electric vehicle. The method includes the steps of providing a mobile charge device comprising a tow truck with a large battery and multiple charging ports. The method also comprises driving the truck device to the stranded electric vehicle. Further, the method comprises securing the charging cable of the electric vehicle to the charging port of the device. The method also comprises charging the electric vehicle via the device. Finally, the method comprises towing the electric vehicle, if necessary.

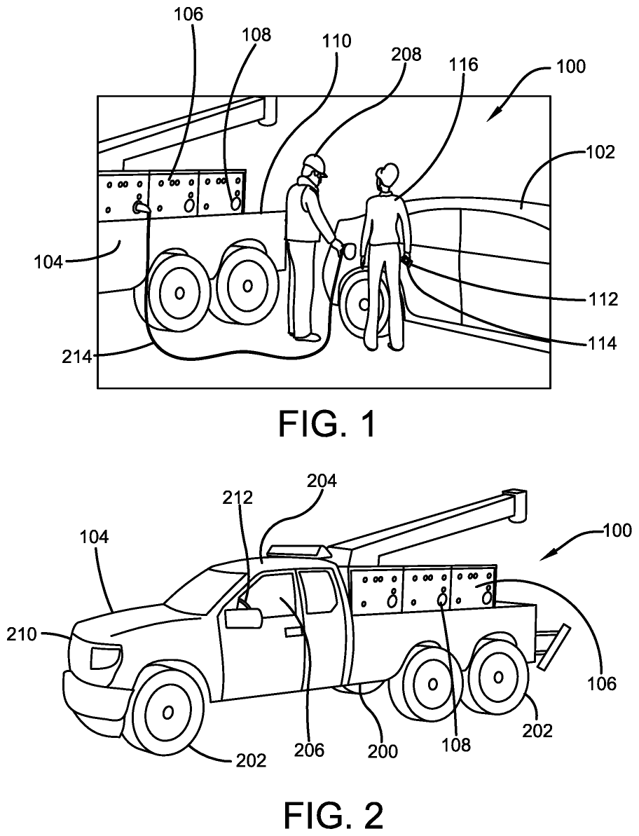

Referring initially to the drawings, FIG. 1 illustrates a perspective view of one embodiment of the mobile charge device 100 of the present invention. In the present embodiment, the mobile charge device 100 is a multifunctional truck device 100 that charges a stranded electric vehicle 102. Specifically, the mobile charge device 100 comprises a tow truck or other suitable vehicle 104 with a large battery 106 in its rear portion 110 and multiple charge ports 108 for charging the stranded electric vehicles 102. Thus, the truck device 100 is useful for helping prevent electric vehicle owners from being stranded for long periods of time without battery charge.

Further, communications between the mobile charge device 100 and the EV 102 are accomplished using software applications, texts, emails, phone calls, etc. In every particular embodiment of the invention, the mobile charge device 100 is a motorized vehicle 104, not a device that is passively carried or pulled.

In one embodiment, the mobile charge device 100 utilizes a software mobile application 112 for providing communications and control from the mobile charge device 100 through a wireless communications interface. In general, these apps 112 are software applications running on smart devices 114 with wireless connectivity and access to the internet. The mobile charge device 100 is continuously tracked and its itineraries are refreshed continuously as submitted by the operator/driver 208 on the software mobile application 112. When a driver 208 submits a routing plan via the mobile app 112 that is connected to the internet cloud or other wireless communication network/environment, a user 116 can determine whose operating areas coincide with the user's position. The mobile charge device 100 can also be tracked via GPS. Further, the software application 112 can provide for electronic recordkeeping and payment processing. However, payment mechanisms are universally available from third parties and other forms of payment processing can be utilized as well, such as the use of on-site magnetic card readers, smart chip card readers, and even online internet data entry through third-party portals for payment processing.

As shown in FIG. 2, the growing deployment of electric vehicles 102 create a need for widespread electrical chargers that are conveniently and strategically located at points of interest. In one embodiment, the mobile charge device 100 comprises a large battery 106 and a plurality of charge ports 108 for charging electric vehicles 102. The battery 106 and charge ports 108 are incorporated into a mobile charging platform such as a truck, a tow truck, a van, or other suitable vehicle that can be transported, and which can then be dispatched on an “as-needed” basis to meet a requesting driver of an electric vehicle 102 at a pre-arranged location for a charging session. In one embodiment, the mobile charge device 100 comprises a tow truck 104 that is also able to tow the EV 102, if needed.

Furthermore, the mobile charge device 100 comprises a chassis (or body) 200, which is substantially supported by approximately four to six wheels 202. Wheels 202 can be selected to permit the mobile charge device 100 to travel on road and/or off road, as desired. The chassis 200 can additionally include an operator's compartment or cab 204, from which the battery 106 and charging ports 108 can be operated. The operator's compartment 204 can include windows 206 or viewing ports to permit the operator/driver 208 to see outside the compartment 204. In one particular embodiment of the invention, the operator's compartment 204 is mounted to the front portion 210 of the chassis 200. Additionally, a steering mechanism 212 is provided within the operator's compartment 204 to enable an operator 208 to steer the wheels 202 and to proceed in the forward and reverse directions.

Additionally, the mobile charge device 100 comprises a large battery 106 or battery system (i.e., multiple batteries connected together), wherein each battery 106 comprises a plurality of charging ports 108 or electrical sockets for connection to an electric vehicle 102 to be charged or to an external charging source. For example, the charging ports 108 permit the electric vehicles 102 to be attached via their charging cords 214 to the battery 106, to charge the electric vehicle 102, or the charging ports 108 can be used to attach the battery 106 to an external power source, such as an off-grid or on-grid power supply (not shown).

Furthermore, each battery 106 stores a maximum of approximately 100 DC volts which can be drawn upon for recharging an electric vehicle 102. The battery 106 may supply power for the mobile charge device 100 or an engine powered electrical generator. In one embodiment, the mobile charge device 100 would comprise a Level-1, Level-2, or Level-3 charger. A Level-2 charger would take at least an hour to provide sufficient charge for the EV 102 to travel between 25 to 50 miles. A Level-3 DCFC fast charger may only require 15 minutes of charging time to provide the equivalent amount of charge as a Level-2 charger taking 2 hours.

All Level-1, Level-2, and/or Level-3 chargers and associated equipment and accessories are compliant with current governing standards of design and use, and as standards evolve and are adopted this invention assumes compliance with all necessary standards and governing bodies.

Further, electricity produced from a power source is regulated by a regulator and stored in the battery 106 or batteries. In one embodiment, the mobile charge device 100 employs multiple power sources for its own recharging, during operation. In one embodiment, the mobile charge device 100 includes solar panels and a wind turbine for generating power from the wind. Power generated is stored in a battery 106 or batteries in combination with supercapacitors onboard the mobile charge device 100.

In the embodiment where a battery system 106 is utilized, the battery system 106 may be replenished either continuously or occasionally via plugging into the grid, or by trickle charging via an on-board solar cell array(s), a wind generator, or even a small powered electrical generator. In other words, the mobile charge device's battery system 106 must be recharged whenever it is discharged in charging an EV 102, and this invention contemplates some mechanism for recharging the onboard charger battery system 106.

Specifically, the mobile charge device 100 described herein, by way of its multiple charging mechanisms, has the ability to operate continuously with no external recharging connection, such as the electrical grid, as well as having the ability to recharge other separate electrical vehicles 102 requiring a charge, in any remote or urban location.

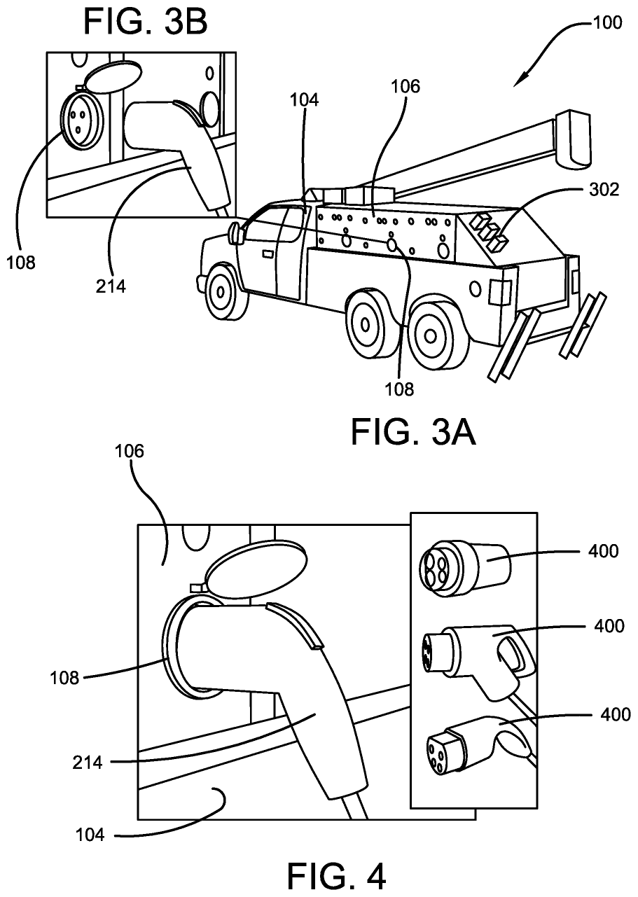

As shown in FIG. 3, since power can be received from and provided to, the mobile charge device 100, electrical connections 300, sockets, or outlets are placed at various locations on the mobile charge device 100. Electrical connections 300 permit the mobile charge device 100 to be recharged from an external source, as well as provide power to other electric vehicles 102 that need to be charged.

In another embodiment, the device 100 may utilize modules 302 of removable batteries wherein the electric vehicle 102 may simply exchange depleted batteries for a set of fully charged batteries 302 and thus, eliminate the waiting time associated with charging the electric vehicle's onboard batteries.

Accordingly, the mobile charge device 100 consists of a vehicle 104 or other transportable platform/container that is equipped with chargers powered by electricity generators that run on gasoline, diesel fuel, or another motor powered source, or banks of batteries 106 capable of supplying continuous, direct current that may be used as is, or converted to various DC voltages, or converted into AC power, or modules 302 of removable batteries that can be exchanged with depleted batteries in the electric vehicle 102.

Further, the mobile charge device 100 comprises charging circuitry which utilizes power from either the local power grid or a local battery source to generate a charging current that is output via the charge port 108 to the electric vehicle 102 being charged. The charging circuitry can receive the charging power from either the electrical power grid via an electric grid connection or a local battery. The electric grid connection would comprise a standard power interface to the local power grid. A battery 106 would locally store electricity that was provided via some type of power generation interface or from the electric grid connection. The power generation interface could be connected to a solar, wind, or other type of power generation system.

As shown in FIG. 4, this invention also contemplates the need for the mobile charge device 100 to carry different charger types 400 and charging cables to manage compatibility with different makes of EVs 102. Specifically, EV designs usually differ in make and model of EVs as each may be equipped with different battery technology, different charging mechanisms, and battery management systems, capacity, etc. Thus, each EV 102 has a charging protocol that may differ from one another, such as in the charging rate, ambient temperature, etc. The mobile charge device 100 controls these protocols and monitors the amount of energy used in recharging the EV 102, the time of the charging sequence, etc. Thus, the mobile charge device 100 provides the ability to match brand specific electric vehicles with brand compatible charging units.

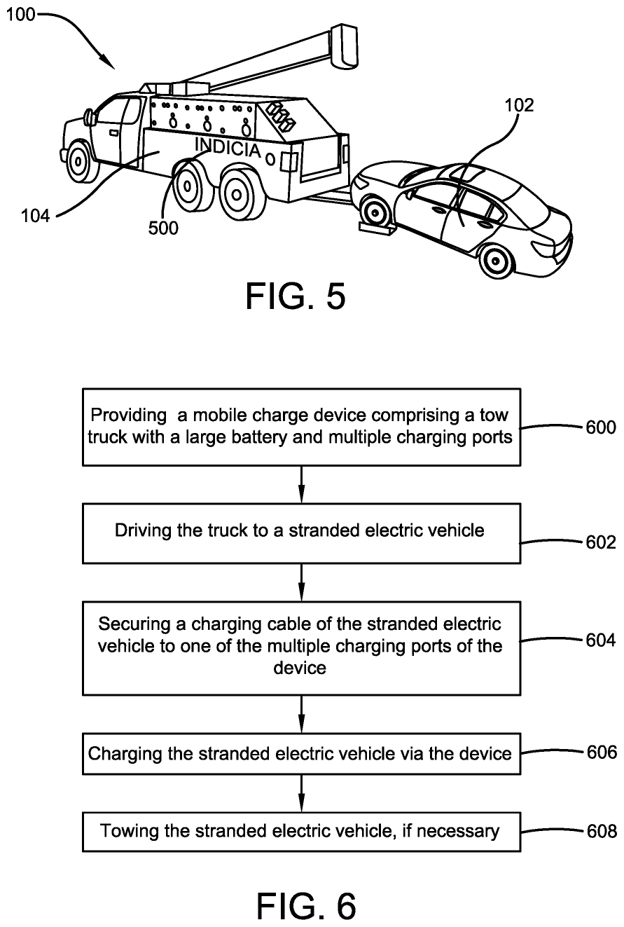

As shown in FIG. 5, multiple mobile charge devices 100 are utilized to allow at least one mobile charge device 100 to be available around the clock, 7 days a week and 24 hours a day. The mobile charge device 100 can be continuously monitored and tracked via the software application 112 and GPS. Specifically, the mobile application 112 provides position information using various applications such as GPS, cell tower triangulation techniques, or using location sensitive beaconing technologies, such as Apple Computer's Bluetooth app, iBeacon, to locate the electric vehicle 102. Accordingly, users 116 can make any requests for charging directly on the software application 112 or directly with the driver 208. Thus, bookings between the mobile charge device 100 and the user 116 may be made either by manual interaction between a driver 208 or through the app 112.

Thus, the mobile charge device 100 provides a roving charging station on a moving platform, such as a tow truck 104 equipped with fossil fuel motorized electric generators or a bank of batteries 106 that are either charged from the normal grid outlet such as 110 V AC wall circuit and/or are continuously charged on the road via onboard solar panels or energy collection mechanism, such as wind turbines or the vehicles 12 V DC output.

It will be appreciated by those skilled in the art having the benefit of this disclosure that the mobile charge device 100 provides a tremendous utility to the EV driver 116 while reducing the need for and cost of installing, fixed EV charging stations that can never keep up with the growth of EV adoption. Mobile EV charging stations also remove, or greatly reduce, range anxiety or the fear of running out of battery charge far away from fixed EV charging stations. By enabling EV charging stations to be mobile, drivers 208 need not delineate from taking direct routes to their intended destinations merely to be close to fixed EV charging stations that are out of their intended trip paths.

In yet another embodiment, the mobile charge device 100 comprises a plurality of indicia 500. The body 200 of the device 100 may include advertising, trademark, other letters, designs, or characters, printed, painted, stamped, or integrated into the body 200, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be electric, charging, or brand related.

The mobile charge device 100 may be a standalone device that can be retrofitted to an existing truck, or a smaller version that would be portable similar to a gas can.

FIG. 6 illustrates a flowchart of the method of charging a stranded electric vehicle. The method includes the steps of at 600, providing a mobile charge device comprising a tow truck with a large battery and multiple charging ports. The method also comprises at 602, driving the truck device to the stranded electric vehicle. Further, the method comprises at 604, securing the charging cable of the electric vehicle to the charging port of the device. The method also comprises at 606, charging the electric vehicle via the device. Finally, the method comprises at 608, towing the electric vehicle, if necessary.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “mobile charge device”, “charge device”, “truck device”, and “device” are interchangeable and refer to the mobile charge device 100 of the present invention.

Notwithstanding the foregoing, the mobile charge device 100 of the present invention can be of any suitable size and configuration as is known in the art without affecting the overall concept of the invention, provided that it accomplishes the above-stated objectives. One of ordinary skill in the art will appreciate that the mobile charge device 100 as shown in FIGS. 1-6 are for illustrative purposes only, and that many other sizes and shapes of the mobile charge device 100 are well within the scope of the present disclosure. Although the dimensions of the mobile charge device 100 are important design parameters for user convenience, the mobile charge device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile charge device that charges a stranded electric vehicle, the mobile charge device comprising:
a vehicle; and
at least one battery;
wherein the at least one battery comprises a plurality of charge ports for charging the stranded electric vehicle;
wherein the vehicle is a motorized vehicle that is mobile; and
further wherein the mobile charge device prevents the stranded electric vehicle from being stranded for long periods of time without battery charge.

2. The mobile charge device of claim 1, wherein the vehicle is a tow truck.

3. The mobile charge device of claim 2, wherein the vehicle comprises a chassis supported by six wheels.

4. The mobile charge device of claim 3, wherein the chassis comprises an operator's compartment with windows and a steering wheel.

5. The mobile charge device of claim 4, wherein the at least one battery is a battery system comprising a plurality of batteries connected together.

6. The mobile charge device of claim 4, wherein the at least one battery is recharged whenever it is discharged in charging the stranded electric vehicle.

7. The mobile charge device of claim 6 further comprising electrical connections positioned at various locations on the mobile charge device.

8. The mobile charge device of claim 7, wherein the mobile charge device may utilize modules of removable batteries wherein the stranded electric vehicle may exchange depleted batteries for a module of fully charged batteries.

9. The mobile charge device of claim 8, wherein communications between the mobile charge device and the stranded electric vehicle are accomplished using software applications, texts, emails, or phone calls.

10. The mobile charge device of claim 9, wherein the mobile charge device utilizes a software mobile application for providing communications and control from the mobile charge device through a wireless communications interface.

11. The mobile charge device of claim 10, wherein the software mobile application utilized GPS to track the vehicle and the stranded electric vehicle.

12. The mobile charge device of claim 11, wherein the mobile charge device carries different charger types and charging cables to manage compatibility with different makes of electric vehicles.

13. A mobile charge device that charges a stranded electric vehicle, the mobile charge device comprising:
a tow truck vehicle; and
at least one battery;
wherein the at least one battery comprises a plurality of charge ports for charging a stranded electric vehicle;
wherein the tow truck vehicle is a motorized vehicle that is mobile;
wherein the mobile charge device prevents the stranded electric vehicle from being stranded for long periods of time without battery charge;
wherein the at least one battery is recharged whenever it is discharged in charging the stranded electric vehicle;
wherein the mobile charge device carries different charger types and charging cables to manage compatibility with different makes of electric vehicles; and
further wherein communications between the mobile charge device and the stranded electric vehicle are accomplished using a software application, a text, an email or a phone call.

14. The mobile charge device of claim 13 further comprising a plurality of indicia.

15. The mobile charge device of claim 13, wherein the at least one battery is a battery system comprising a plurality of batteries connected together.

16. The mobile charge device of claim 13, wherein the mobile charge device utilizes a software mobile application for providing communications and control from the mobile charge device through a wireless communications interface.

17. The mobile charge device of claim 16, wherein the software mobile application utilized GPS to track the vehicle and the stranded electric vehicle.

18. The mobile charge device of claim 13, wherein the mobile charge device may utilize modules of removable batteries wherein the stranded electric vehicle may exchange depleted batteries for a module of fully charged batteries.

19. The mobile charge device of claim 13, wherein the vehicle comprises a chassis supported by six wheels and an operator's compartment with windows and a steering wheel.

20. A method of charging a stranded electric vehicle, the method comprising the following steps:
providing a mobile charge device comprising a tow truck with a battery and a plurality of charging ports;
driving the tow truck device to a location of the stranded electric vehicle;
securing a charging cable of the stranded electric vehicle to one of the plurality of charging ports;
charging the stranded electric vehicle via the battery of the mobile charge device; and
towing the stranded electric vehicle, if necessary.
